(19) United States
(12) Patent Application Publication
(10) Pub. No.: US 2004/0041037 A1
(43) Pub. Date: Mar. 4, 2004

(54) Injection valve comprising a pump piston

(76) Inventors: Wendelin Klugl, Seubersdorf (DE); Gunter Lewentz, Regensburg (DE); Martin Neumaier, Regensburg (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/399,076

(22) PCT Filed: Sep. 19, 2001
(86) PCT No.: PCT/DE01/03616

(30) Foreign Application Priority Data
Oct. 12, 2000 (DE) 100 50 599.6

(51) Int. Cl. F02M 51/00; F02M 59/00

(52) U.S. Cl. 239/533.2; 239/585.1

(57) ABSTRACT

The invention relates to an injection valve (1) comprising a booster piston (23), said piston delimiting a pump chamber (22) and a booster chamber (29). A valve (14) is provided in the inlet to the chamber (22). The valve is configured as a 3/2-way valve and controls the pressure in the pump chamber (22). The pressure in the pump chamber (22) is converted into a correspondingly increased pressure in the booster chamber (29) and in an injection chamber (34) containing an injection needle (6), by means of the booster piston (23). The use of the valve (14) allows a precise control of the injection times.

The invention relates to an injection valve with a pump piston in accordance with the characterizing clause of patent claim 1.

Injection valves with a pump piston to raise the pressure of the injected fluid are used, for example, in automobile engineering to achieve particularly high injection pressures. For example, in modern common-rail injection systems diesel fuel is injected into the combustion chamber of a internal-combustion engine at a pressure of up to 2000 bar.

A fuel injection system for internal combustion engines by which fuel is fed from a high-pressure accumulator to an injection valve is known from DE 43 11 627 A1. The fuel is fed into a pump chamber which is delimited by one face of a pump piston. A second face of the pump piston delimits a booster chamber, which contains an injection needle. This injection needle is preloaded against the sealing seat, so that in its closed position the booster chamber is isolated from the spray holes. The injection needle is linked to a second piston, which delimits a control chamber. This control chamber is linked to a 3/2-way valve by a bore hole. The 3/2-way valve is in turn connected to a high-pressure accumulator by a second line, and via a third tube to a discharge line. The positional setting of the 3/2-way valve determines a predefinable pressure setting for the control chamber, and this controls the position of the injection needle. An additional controllable valve is provided between the high-pressure accumulator and the pump chamber, and this links the high-pressure chamber to the pump chamber as determined by the positional setting of the controllable valve. Control of the injection process is exercised by the positional settings of the 3/2-way valve and the additional valve.

It is the function of the invention to provide a simplified injection valve.

The function of the invention is effected by the features of claim 1. An advantage of the invention is that it is not necessary to have two controllable valves, but rather the injection is controlled by a single valve. In this case, the single valve is located in the feed line before the pump chamber. This provides a low-cost injection valve, which at the same time permits precise control of the injection process.

Further advantageous forms of embodiment of the invention are specified in the dependant claims. One advantageous form of embodiment of the valve consists in the use of a 3/2-way valve, by which a first line connection from an input line is linked to a second line connection to a first feeder line and a third line connection to a discharge line. The use of the 3/2-way valve makes it possible to exercise precise control of the position of the injection needle.

In one preferred form of embodiment of the valve, a first valve chamber is provided with a first closing element, such that the input line opens into the first valve chamber and the first closing element holds an outflow opening open or closed depending on its positional setting.

A preferred form of embodiment of the first closing element and sealing seat consists of a conical sealing surface, by which a simple and tight seal can be effected for the first valve chamber.

Preferably, the first closing element is connected to a second closing element by a rod. The second closing element is located in a second valve chamber and the rod passes through a connecting hole which links the first and second valve chambers to each other. In addition, a discharge line is connected to the second valve chamber. Depending on the positional setting of the valve, either the discharge line or the input line is connected to the feeder line.

The second valve element will preferably be linked so that it works in conjunction with an actuator which sets the positional setting of the first and second closing elements. The use of a single actuator for the first and second closing elements provides a simple form of embodiment of the valve.

In a preferred form of embodiment, the first and second valve chambers are arranged along an axis, which is located either parallel to or along a central axis of symmetry of the injection valve. In this way a slim construction can be achieved for the injection valve.

In an advantageous instance of the invention, a piezoelectric actuator is used to actuate the valve. To achieve a slim construction for the injection valve, it is of advantage if the piezoelectric actuator is located at the top end of the housing, with the piezoelectric actuator being partially inserted into the housing. In this way, a slim construction is achieved.

The piezoelectric actuator will preferably be arranged to be symmetrical with respect to the centre of the injection valve, as this will provide a particularly slim form for the design of the injection valve.

In a further preferable form of embodiment, the third and fourth sealing surfaces of the second valve chamber and second closing element respectively take the form of flat surfaces. This form of embodiment permits low-cost manufacture of the third and fourth sealing surfaces, while also enabling a good seal to be effected. The operability of the pump piston is preferably improved by its first face having a recess which can be seated on a landing surface on the housing, such that the feeder line opens into the pump chamber in the vicinity of the landing surface. This will ensure that even when the pump piston is at its maximum displacement, the pump chamber retains a residual space, so that when the pump chamber is connected to the input line the pump chamber will rapidly fill with fluid, so that a rapid pressure rise is achieved in the injection chamber. The rapid rise in pressure makes it possible to exercise precise control over the start of the injection process.

The invention is explained below in more detail by reference to the figures. These show

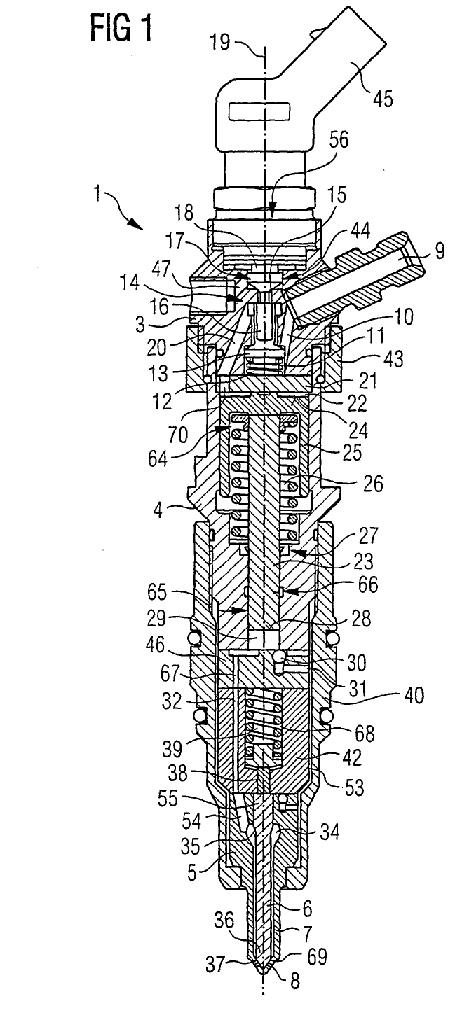

FIG. 1 an injection valve as a schematic partial cross-section,

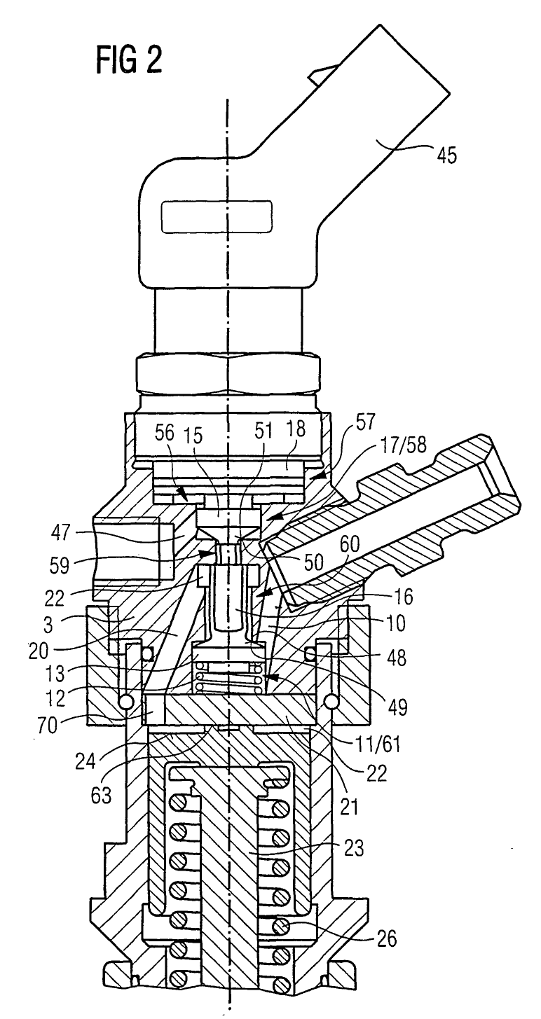

FIG. 2 an enlarged extract of part of the injection valve, and

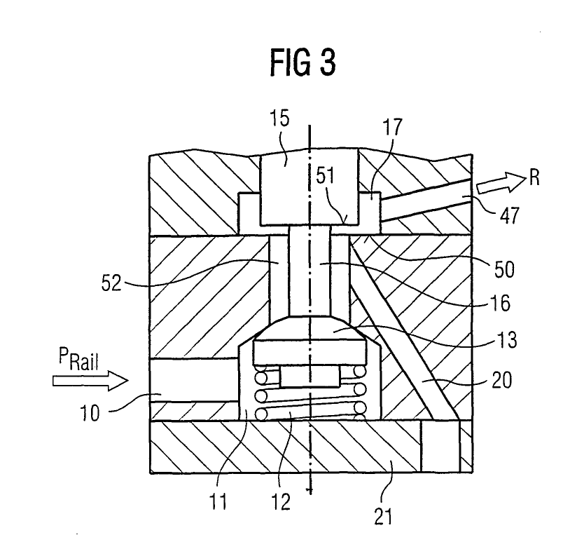

FIG. 3 a further form of embodiment of a valve to control the pressure in a booster chamber.

FIG. 1 shows a schematic diagram of an injection valve 1 with a central axis of symmetry 19, such as might be used for injecting diesel fuel into a diesel internal-combustion engine. The injection valve 1 has a valve body 3, which is attached to a pump body 4 by a sleeve 43. The pump body 4 is attached to a separator 46, a spring holder 42 and a nozzle body 5 by a sleeve 40.

The valve body 3 has an input connector 9, which is connected to an input line 10. The input line 10 feeds into a first valve chamber 11. This first valve chamber 11 is a part of the through borehole 56, which passes through the valve body 3 symmetrically with respect to the central axis. Into the top end of the through borehole 56 is screwed an actuator 18, which seals off the top end of the through borehole 56. At the bottom end of the through borehole 56 is fitted a landing plate 21, which sits in a circular rebate on the pump body 4 and is pressed against the valve body 3 by the pump body 4, and which seals the bottom of the through borehole 56. The landing plate 21 thus delimits the first valve chamber 11. In the valve body 3 is fitted a valve 14, which is configures as a 3/2-way valve. As connections, the valve 14 has the input line 10, a first feeder line 20 and a discharge line 47. Depending on the setting of the valve 14, either the input line 10 or the discharge line 47 is connected to the first feeder line 20.

The first feeder line 20 feeds through a borehole 70 in the landing plate 21 to a pump chamber 22. Underneath the landing plate 21 and in the pump body 4 is located a moveable pump piston 64, the first face of which 24 delimits the pump chamber 22, which is formed within the pump body 4 between the landing plate 21 and the first face 24.

At the top of the pump piston 64 there is a cup-shaped shell, which is inserted into the pump body 4 to seal it off, and on which is the first face 24. Located within the shell 25 is a booster piston 23, which is preloaded towards the first face 24 by a second spring element 26. This second spring element 26 presses against a step in the pump body 4. At the top end of the booster piston 23, a landing ring is formed, against which the second spring element 26 presses. The bottom end of the booster piston 23 projects into a guide borehole 65 in the pump body 4 and seals this borehole. The booster piston 23 has a second face 28, which has a smaller cross-section than the first face 24 and which delimits a booster chamber 29, which is formed within the pump body 4. Preferably, between the pump body 4 and the booster piston 23 are located sealing elements 66, to seal the booster chamber. As an example, a sealing ring could be used as the sealing element.

The pump body 4 sits on the separating plate 46. The booster chamber 29 is thus delimited by the separating plate 46, the pump body 4 and the booster piston 23. Through the separating plate 46 there is a first borehole 67 which connects the booster chamber 29 with a third feeder line 32, which passes through the spring holder 42. The spring holder 42 abuts against the separating plate 46. In addition, there is a second feeder line 31 through the separating plate 46 which forms a connection, via an input valve 30, between the booster chamber 29 and a fuel chamber 53. The fuel chamber 53 is supplied via channels which are not shown with fuel at a low pressure. The input valve 30 ensures that the booster chamber 29 is always completely filled with fuel.

The third feeder line 32 leads to the nozzle body 5, and opens into a fourth feeder line 54 in the nozzle body 5, which leads to an injection chamber 34. The nozzle body 5 contains an injection needle 6 which can move axially, which in the region of the injection chamber 34 has a pressure surface 35. The injection needle 6 has a needle point 36, located in the region of the point of the nozzle body 5. There are spray holes 8 through the point of the nozzle body 5. The needle point 36 has a needle seat 37 which is located above the spray holes 8 and which has an associated sealing seat 69 built up on the nozzle body. If the injection needle 6 is positioned with the needle seat 37 on the sealing seat 69, there is then no connection between the injection chamber 34 and the spray holes 8. However, if the injection needle 6 with the needle seat 37 is lifted off the sealing seat 69, there is then a hydraulic connection between the injection chamber 34 and the spray holes 8, so that fuel from the injection chamber 34 is dispensed through the spray holes 8.

At the upper end of the injection needle 6 there is a guide section, which passes through a guide borehole in the nozzle body 5 and seals it hydraulically. The guide section 55 is attached to a connecting rod 38, which projects into the spring holder 42. The connecting rod 38 is attached to a third spring element 39, which is located in a spring chamber 68 in the spring holder 42. This third spring element 39 presses against the separating plate 46 and loads the injection needle 6 towards the sealing seat 69, which is located above the spray holes 8. If the fuel in the injection chamber 34 has a low pressure, then the injection needle 6 is pressed against the sealing seat 69 by the third spring element 39, so that there is no connection between the pump chamber 34 and the spray holes 8.

However, if the pressure in the injection chamber 34 is increased by a compression movement of the booster piston 23, then the pressure acts on the pressure surface 35 and, when the pressure required to raise it against the loading of the third spring element 39 is reached, will lift the injection needle 6 from the sealing seat, so that there is a hydraulic connection between the injection chamber and the spray holes 8. With the injection needle 6 in this position, fuel from the injection chamber 34 is dispensed through the spray holes 8.

Fuel which escapes from the injection needle 6 through a gap in the seal around the guide section 55 is bled off via a leakage valve 41 to the fuel chamber 53.

The positional setting of the valve 14 controls the pressure in the pump chamber 22, and thereby the compression stroke of the booster piston 23. The area of the first face 24 is greater than the area of the second face 28, so that a pressure increase is achieved between the pressure in the pump chamber 22 and the pressure in the booster chamber 29 and in the injection chamber 34.

The way in which the valve 14 functions is explained in more detail by reference to FIG. 2.

FIG. 2 shows an enlarged diagram of the valve body 3. The valve body 3 has a central through borehole 56, which is sealed off at its upper end by the actuator 18 and at its lower end by the landing plate 21. The through borehole 56 has an initial upper section 57 into which is screwed the actuator 18 with its housing. There is a step between the first section 57 and a second section 58, which represents a second valve chamber 17. This second section 58 has a smaller cross-section than the first section 57. The second section 58 is adjoined in turn by a third section 59, with this third section 59 having a smaller cross-section than the second section 58. The third section 59 is adjoined by yet a fourth section 60, which has a larger cross-section than the third section 59. The fourth section 60 is divided by a step from an adjoining fifth section, which has a larger cross-section than the fourth section 60. The fifth section represents the first valve chamber 11.

The actuator 18 is preferably constructed as a piezoelectric actuator, with electrical connections 45. Control wires are connected to the electrical connections 45, these being linked to a control device. This control device controls the actuator 18 in accordance with prescribed procedures and depending on the operating parameters of the internal combustion engine.

The actuator 18 is linked so that it works in conjunction with a second closing element 15, this second closing element 15 being located in the second valve chamber 17. The second closing element 15 has a fourth sealing surface 51, which is associated with a third sealing surface 50. The third sealing surface 50 is built up on the valve body 3 in the transitional area between the second and third sections 58, 59. Furthermore, the second closing element 15 has a rod 16, which passes through the third section 59 and the fourth section 60 to the first valve chamber. The rod 16 is attached to the first closing element 13, which is essentially located in the first valve chamber 11. The first closing element 13 has a second sealing surface 49, which is associated with a first sealing surface 48. The first sealing surface 48 is located on the valve body 3 in the transition area between the fourth and fifth sections 60, 61. Located in the first valve chamber 11 is a first spring element 12, which preloads the first closing element 13 in the direction of the first sealing surface 48.

The second sealing surface 49 on the first closing element 13, and the fourth sealing surface 51 on the second closing element 15, are preferably constructed as conical surfaces. So too, it is preferable that the third and first sealing surfaces, 50, 48 are correspondingly constructed as conical surfaces, to ensure that a secure seal is effected by the first and second closing elements 13, 15. The rod 16 spaces the first and the second closing elements 13, 15 and connects them together permanently in such a way that, depending on the positional displacement of the actuator 18, the first or the second closing element 13, 15 sits on its associated sealing seat 48, 50 and thus either the input line 10 or the discharge line 47 is connected to the first feeder line 20. To achieve this, the rod 16 is made with a smaller cross-section than that of the second and third sections 59, 60 of the through borehole 56.

Preferably, the fourth section 60 will have an enlarged annular channel 62, to which the first feeder line 20 is connected. This will ensure an improved hydraulic feed to the pump chamber 22.

The method of functioning of the invention is now explained by reference to FIGS. 1 and 2. If no fuel is to be injected, the actuator 18 is not activated and the first closing element 13 remains on its associated sealing seat 48, so that there is no connection between the connection 9 and the pump chamber 22. As a result, the pump piston 64 remains in the upper position due to its preloading by the second spring element 26, and no high pressure is generated in the injection chamber 34. In consequence, the injection needle 6 is pressed against its associated sealing seat 69 by the third spring element 39, and there is no connection between the injection chamber 34 and the spray holes 8. In addition, the pump chamber 22 is connected to the discharge line 47 via the first feeder line 20 and the fourth, third and second sections 60, 59, 58. The discharge line 47 is connected to a return line and is only at a low pressure. The pump chamber 22 is thus under only low pressure.

Preferably, the face 24 will have a raised landing surface 63, which can be seated on the landing plate 21 when the pump chamber 22 is under no pressure. The landing surface 63 should preferably be ring shaped in construction and has the advantage that in the region of the borehole 70, through which the first feeder line 20 opens into the pump chamber 22, there is a defined gap between the first face 24 and the landing plate 21, so that there is always a residual space in the pump chamber 22. Due to this residual space, when the valve 14 is opened fluid will be forced into the pump chamber 22 and will apply the prescribed pressure to the total area of the first face 24, so that movement of the pump piston will be rapidly effected.

If fuel is to be injected, the control device will activate the actuator 18 in such a way that it makes a downward excursion, and thereby presses the second closing element 15 with the fourth sealing surface 51 onto the associated third sealing surface 50, thus breaking the connection between the discharge line 47 and the first feeder line 20. Simultaneously, this movement of the second closing element 15 is transmitted by the rod 16 and pushes the first closing element 13 away from the first sealing surface 48, thus opening a connecting area between the first feeder line 20 and the input line 10. The input line 10 is connected via the input connector 9 to a fluid reservoir, preferably a reservoir of fuel at a prescribed pressure. Hence the fluid will flow into the pump chamber 22 at the prescribed pressure, and will press the pump piston 64 in a downward direction, against the preloading force due to the second spring element 26, towards the booster chamber 29. The booster chamber 29 is completely full of fuel, so that the pressure through the first borehole 67, the fourth feeder line 54, the third feeder line 32 and in the injection chamber 34 is increased. If the pressure in the injection chamber 34 rises above a prescribed lift-off pressure, then the pressure on the pressure surface 35 acts against the preloading force of the third spring element 39 to lift the injection needle 6 from the sealing seat, so that fuel is dispensed from the injection chamber 34 through the spray holes 8.

The fuel reservoir used should preferably a fuel store of the type referred to as a common-rail, by which the input connection 9 is supplied with fuel under a pressure of up to 500 bar.

When fuel injection is to be terminated, the actuator will be appropriately activated so that it withdraws in an upward direction. As a consequence, the spring element 12 will move the first and second closing elements 13, 15 into the closed position, with the first closing element 13 landing on the first sealing surface 48 and the second closing element 15 being lifted in an upward direction off the third sealing surface 50. As a result, the connection between the input line 10 and the first feeder line 20 is broken, and the first feeder line 20 is again connected to the discharge line 47. This allows the fluid present in the pump chamber 22 to escape via the discharge line 47. As a result, the booster piston 23 is moved in an upward direction by the second spring element 26. In consequence, the pressure drops in the injection chamber 34 and the injection needle 6 is pressed against the sealing seat 69 by the third spring element 39. When the injection needle 6 has landed on the sealing seat 69, the connection between the injection chamber 34 and the spray holes 8 is broken, so that fuel injection is terminated.

FIG. 3 shows a further form of embodiment of the invention, in which the fourth sealing surface 51 on the second closing element 15 takes the form of a plane surface, which is associated with a correspondingly planar form for the third sealing surface 50. These forms of embodiment for the fourth and third sealing surfaces 51, 50 are simple and cheap to manufacture.

In a further advantageous form of embodiment, several first feeder lines 20 are provided, connecting the valve 14 with the pump chamber 24. This arrangement of several first feeder lines 20 permits faster filling and emptying of the pump chamber 24.

1. Injection valve with a housing, with an input line (10) which feeds into a pump chamber (22) via a controllable valve (14),
with a piston (64), a first face (24) of which delimits the pump chamber (22),
in which a second face (28) of the piston (64) delimits a booster chamber (29),
in which the booster chamber (29) can be connected to a fuel reservoir via a second valve (30),
with an injection chamber (34) which is connected to the booster chamber (29),
with a moveable injection needle (6) which projects into the injection chamber (34),
with the injection needle (6) having a pressure surface (35), these being located in the injection chamber (34), where, depending on a positional setting, the injection needle (6) opens or closes a connecting area between the injection chamber (34) and a spray hole (8),
with which a pressure in the pump chamber (22) is transmitted by the piston (64) to produce a higher pressure in the booster chamber (29) and in the injection chamber (34), characterized by the fact
that the valve (14) controls the pressure in the pump chamber (22), and that the positional setting of the injection needle is set by the pressure in the pump chamber (22).

2. Injection valve in accordance with claim 1, characterized by the fact
that the valve (14) is configured as a 3/2-way valve with three line connections,
that a first line connection is connected to an input line (10),
that a second line connection is connected to a first feeder line (20),
that a third line connection is connected to a discharge line (47), and
that, depending on the positional setting of the valve (14), the first supply line (20) is connected either to the input line (10) or to the discharge line (47).

3. Injection valve in accordance with one of the claims 1 or 2, characterized by the fact
that the input line (10) opens into a first valve chamber (11),
that the first valve chamber (11) has an outflow opening and that round the outflow opening a sealing seat (48) is formed, that the sealing seat (48) has an associated first closing element (13),
that the outflow opening is connected to the first feeder line (20), and
that, depending on the position of the first closing element (13), the first valve chamber (11) is either connected or not connected to the first feeder line (20).

4. Injection valve in accordance with claim 3, characterized by the fact
that the first closing element (13) has a conical sealing surface (49), and
that the sealing seat (48) has a conical second sealing surface.

5. Injection valve in accordance with one of the claims 3 or 4, characterized by the fact
that the first closing element (13) is connected by a rod (16) to a second closing element (15),
that the second closing element (15) is located in a second valve chamber (17),
that the first and second valve chambers (11, 17) are connected to each other by a connecting borehole (56),
that the rod passes through the connecting borehole (56), and that the second valve chamber (17) is connected to the discharge line (47).

6. Injection valve in accordance with claim 5, characterized by the fact
that the second closing element (15) is linked so that it works in conjunction with an actuator (18) which determines the positional settings of the first and second closing elements (13, 15).

7. Injection valve in accordance with claim 6, characterized by the fact
that the first and second valve chambers (11, 17) are located along an axis, and
that this axis is located parallel to or preferably along a central axis of symmetry (19) of the injection valve (1).

8. Injection valve in accordance with one of the claims 5 to 7, characterized by the fact
that the second valve chamber (17) has a sealing seat with a third sealing surface (50) around an inlet opening from the connecting borehole (56), and
that the second closing element (15) has a fourth sealing surface (51) which is associated with the third sealing surface (50).

9. Injection valve in accordance with claim 8, characterized by the fact
that the third and fourth sealing surfaces (50, 51) are conical in shape.

10. Injection valve in accordance with one of the claims 1 to 9, characterized by the fact
that the valve (14) is connected to a piezoelectric actuator (18), by which the valve (14) can be operated.

11. Injection valve in accordance with claim 10, characterized by the fact
that the piezoelectric actuator (18) at the upper end of the housing (3) is partially inserted into the housing (3).

12. Injection valve in accordance with claim 11, characterized by the fact
that the piezoelectric actuator (18) is located with its central axis on the central axis of symmetry (19) of the injection valve (1).

13. Injection valve in accordance with one of the claims 8 to 12, characterized by the fact
that the third and fourth sealing surfaces (50, 51) are constructed as plane surfaces and that the connecting borehole (56) is connected to the first feeder line (20).

14. Injection valve in accordance with one of the claims 1 to 12, characterized by the fact
that the first face (24) has a raised landing surface (63), which can be seated on a landing plate (21)
that the first feeder line (20) opens into the pump chamber (22) in a region outside the landing surface (63).
